(19) United States
(12) Patent Application Publication
(10) Pub. No.: US 2008/0211200 A1
(43) Pub. Date: Sep. 4, 2008

(54) Group of Shopping Trolleys and Shopping Trolleys for Forming One Scuh Group

(76) Inventor: Herbert Eberlein, Bubesheim (DE)

Correspondence Address: DAVID A. GUERRA;INTERNATIONAL PATENT GROUP, LLC, 2025 17TH AVENUE N.W., CALGARY, AB, T2M 0S7, CA

(21) Appl. No.: 11/917,707

(22) PCT Filed: Jun. 22, 2006
(86) PCT No.: PCT/DE2006/001067

§ 371 Date: Dec. 14, 2007

(30) Foreign Application Priority Data
Jun. 25, 2005 (DE) 10 2005 029 581.9
Jul. 7, 2005 (DE) 10 2005 031 763.4
Nov. 29, 2005 (DE) 10 2005 056 799.1

(51) Int. Cl. B62D 39/00

(52) U.S. Cl. 280/33.991

(57) ABSTRACT

The invention relates to a group of shopping trolleys formed by at least two different shopping trolleys, respectively comprising an undercarriage and a basket carried by the undercarriage. The same shopping trolleys can be parked in rows, in such a way that the baskets and the undercarriages are partially inserted into each other. At least one connecting means is provided beneath the bottom of the basket and outside the lateral walls of the basket, said connecting means comprising connecting points that enable a basket to be fixed to an undercarriage during the course of the assembly process. The different trolleys are differentiated by at least the different width of the baskets or alternatively by the different width of the undercarriages. The arrangement of at least the connecting points corresponding to the basket, or alternatively at least the connecting points corresponding to the undercarriage is the same for all of the shopping trolleys.

### CROSS-REFERENCE TO RELATED APPLICATIONS

This application is an U.S. national phase application under 35 U.S.C. §371 based upon co-pending International Application No. PCT/DE2006/001067 filed on Jun. 22, 2006. Additionally, this U.S. national phase application claims the benefit of priority of co-pending International Application No. PCT/DE2006/001067 filed on Jun. 22, 2006, German Application No. 10 2005 056 799.1 filed on Nov. 29, 2005, German Application No. 10 2005 031 763.4 filed on Jul. 7, 2005, and German Application No. 10 2005 029 581.9 filed on Jun. 25, 2005. The entire disclosures of the prior applications are incorporated herein by reference. The international application was published on Jan. 4, 2007 under Publication No. WO 2007/000143 A3.

### BACKGROUND OF THE INVENTION

1. Field of the Invention

The invention relates to a range of shopping trolleys which is formed by at least two different shopping trolleys, each of which has a chassis and a basket carried by said chassis, wherein identical shopping trolleys can be parked in rows in such a way that both their baskets and their chassis are partially inserted in one another, and also wherein at least one connecting means located underneath the bottom of the basket and outside the sidewalls of the latter is provided, which has connecting points which allow immovable fastening of a basket on a chassis in the course of an assembling operation.

The invention also relates to a shopping trolley which is suitable for forming a range of shopping trolleys which is equipped with the technical features just described.

2. Description of the Prior Art

Ranges of shopping trolleys are known in which baskets which differ in length and/or height can be selectively attached to one and the same chassis. Conversely, it is possible to provide chassis of different lengths and/or heights for identical baskets. Under these circumstances, the kind of connecting means and their arrangement is chosen in such a way that common connecting points are produced which are always located, at least partially, on the sidewalls of the baskets.

German Utility Model DE 299 07 769 U1 describes a stackable shopping trolley in which there is provided, as the connecting means, an intermediate piece which is located between the chassis and the basket and on the lower region of which there are provided those connecting means which are also located, in known manner, on the sidewalls of the basket, and there are in turn arranged, in the upper region of said intermediate piece, connecting means of this kind which are also located, in known manner, on the chassis. If it is then necessary to produce shopping trolleys in which the basket is of relatively low construction, all that is required is to use the intermediate piece initially described, which thereby arranges the low basket in a higher manner, so that the pushing apparatus is also located at a height which is suitable for the user of the shopping trolley. If it desired to use a relatively high basket with the same chassis, the intermediate piece will be dispensed with since the pushing apparatus is then located at the suitable height in any case, because of the greater height of the basket. In the case of both the shopping trolleys, which together form a range of shopping trolleys, at least some of the connecting means are always located on the sidewalls of the baskets. In this solution, too, the sidewalls are used as the means of fastening the baskets on the chassis.

The intermediate piece itself turns out to be a cost-intensive component, since it has parts which also have to be provided on the basket and on the chassis. So, apart from anything else, four rails are required which are constructed as stamped parts and which have to welded onto the chassis two at a time and onto the intermediate piece two at a time. Intermediate pieces of this type are not ideal for the purposes of producing such shopping trolleys in a cost-effective manner.

British Patent Application GB 2 383 307 A describes a shopping trolley which is intended for a wheelchair-user and can be fastened to a wheelchair, and the basket of which is mounted so as to be rotatable about a perpendicular axis. The rotatable mounting of the basket is made possible by a movable connecting means which connects said basket to the chassis and is designed as a ball bearing. Said ball bearing is located between the bottom of the basket and the chassis. The basket of this shopping trolley is of cylindrical design, so that it is possible for a wheelchair-user to load said basket at various points by rotating it. In the patent application mentioned, it is also pointed out that, instead of a cylindrical basket, a basket of conventional structural type may also be used, so that the said basket is likewise fastened to the chassis in a rotatable manner. The patent application mentioned conveys no indications of any kind concerning the kind of assembling operation which is required in order to be able to connect the basket to the chassis with the aid of a ball bearing and which is, after all, relatively difficult. Also missing from the said patent specification is any statement as to whether its baskets and chassis can be inserted in one another. Finally, it is not possible to find a suggestion of any kind as to how a range of shopping trolleys of the kind initially described might be formed from the shopping trolleys just described.

European Patent Application EP 1 093 987 A2 describes shopping trolleys whose connecting means are formed by two U-shaped clips welded onto the underside of the bottom of the basket, and by hook-in eyelets and fastening eyelets welded onto the chassis. In order to fasten a basket to a chassis, the four U-shaped clips are hooked into the hook-in eyelets and then secured to the fastening eyelets with the aid of separate fastening means to prevent detachment. This method of fastening a basket to the chassis of a shopping trolley requires two U-clips, four hook-in eyelets, four fastening eyelets and also at least four other fastening means, so that the arrangement designed in this way has to be regarded as requiring an extremely large number of parts and therefore as expensive. Since shopping trolleys are to be classified as mass-produced articles, every increase in cost, however small, adds up, in aggregate, to an unacceptable cost factor. As has already been observed in connection with the British patent specification initially described, it is likewise not possible to find, in EP 1 093 987 A2, indications or proposals of any kind as to how it might be possible to form, from the shopping trolleys described, a range of shopping trolleys that corresponds to the range initially mentioned.

Irrespective of the prior art just portrayed, and merely for reasons of cost-reduction apart from anything else, every manufacturer of shopping trolleys endeavors to keep the diversity of different baskets and/or different chassis limited. On the other hand, there is an awareness of the wishes of the supermarket chains, according to which the latter want to know that their shopping trolleys which are in use are exactly matched to their marketing concept, a fact which has led, to date, to the development of the most diverse forms of shopping trolleys. The consequence is that the manufacturers of shopping trolleys have to keep available what are, basically, far too many types of shopping trolleys, in order to be able to survive in the marketplace.

Added to this is the fact that, in the course of maintenance, shopping trolleys put together from a chassis and a basket only allow the replacement of baskets and/or chassis which originate from the same manufacturer and therefore correspond in the design of their connection, which design is peculiar to each manufacturer. This therefore restricts the supermarket chains' ability to:

obtain baskets and/or chassis independently of the particular manufacturer; or

have baskets and/or chassis built with a quality and length of service life which differs and is convenient in each case; or

change only the baskets or the chassis instead of the entire shopping trolleys in the context of changes in concept; or finally

sell baskets or chassis which are no longer needed to maintenance enterprises or other users of the said parts at any time.

The consequence is that, within the total of the restrictions mentioned, the overall costs of purchase, upkeep, recycling and disposal which result from the use of shopping trolleys remain at a high level which is, essentially, determined by the manufacturer. For the supermarket chains, this makes itself felt permanently, in disadvantageous manner, through higher costs.

### SUMMARY OF THE INVENTION

Adopting as the starting point the prior art initially described and the circumstances just portrayed, the object of the invention consists in further developing ranges of shopping trolleys of the generic type in such a way that, while reducing the manufacturing costs, and preferably also the costs of maintenance, recycling and disposal, an increase in the number of different shopping trolleys is nevertheless possible, and that the possibility exists for supermarket chains to be able to provide, configure or change new shopping trolleys and thereby, correspondingly, new ranges of shopping trolleys, from a large number of baskets and chassis, irrespective of the particular manufacturer.

The solution to the object with respect to the range of shopping trolleys consists in the fact that the different shopping trolleys differ at least in the different widths of their baskets or, alternatively, at least in the different widths of their chassis, and that the arrangement, at least of the connecting points which correspond with the basket or, alternatively, at least of the connecting points which correspond with the chassis, is identical in all the shopping trolleys.

The solution with respect to a shopping trolley which is suitable for this purpose consists in the fact that at least the connecting points which correspond with the basket are designed in such a way that said basket can be attached to the at least one connecting means by latching-type locking.

By means of the solutions proposed with respect to the range of shopping trolleys and to a shopping trolley which is suitable for this purpose, use may now be made, in an advantageous and cost-effective manner, of chassis and baskets which differ not only, as before, in their length and height, but also in their width as well, so that the number of different shopping trolleys within a range of shopping trolleys can be decisively increased. The comparison which is made below makes it possible to identify this first advantage of the solution discovered, by comparison with the prior art.

Prior art: The following are available:

a single type of chassis in four patterns and also, in each case:

a matching low, long basket;

a matching low, short basket;

a matching high, long basket;

a matching high, short basket.

A range of shopping trolleys is obtained, which is formed by four different trolleys.

According to the invention, the following are now available:

the same type of chassis in eight patterns and also, in each case:

a matching narrow, low, long basket;

a matching narrow, low, short basket;

an intended for that purpose narrow, high, long basket;

a matching narrow, high, short basket;

a matching wide, low, long basket;

a matching wide, low, short basket;

a matching wide, high, long basket;

a matching wide, high, short basket.

A range of shopping trolleys is obtained, which is formed by eight different trolleys, a fact which means an increase of 100%, while using chassis which are always identical.

Since shopping trolleys differ, as a rule, in the different volume of their baskets and the chassis is, basically, only there in order to be able to move the shopping trolley, this fact results in a further, quite decisive advantage which consists in the fact that it is possible, as a result of the idea according to the invention, to form, in a preferred manner, ranges of shopping trolleys in which the share accounted for by the different baskets is larger than the share accounted for by the different chassis. This circumstance proves to be extremely convenient with respect to efficient and cost-effective production of shopping trolleys since the small number of different types of chassis required can now be manufactured in substantially greater numbers of pieces, and thus more cheaply, for the purposes of the manufacturers of shopping trolleys. Even if, in the end, the number of different types of basket becomes larger, the manufacturing costs can still be decisively reduced as a result of the design of the connecting means, which is always identical, and the arrangement of the connecting points, which is likewise always identical. Even the assembly costs which arise in the case of factory assembly of the shopping trolleys can be considerably diminished if the connecting means and connecting points are constructed, in a preferred manner, in such a way that the baskets can be attached to the chassis by latching-type locking, without any other fastening means being required.

The standardization, which is achieved by means of the solution of the invention, of the kind of connection between baskets and chassis also proves, to mention the third advantage of the invention, extremely cost-effective and convenient for the supermarket chains. Said supermarket chains now have the possibility of not only seeking out the most favorable manufacturer of baskets and chassis in each case, referred to the intended location of use of the shopping trolleys, and therefore of the ranges of shopping trolleys, in each case, but it is also possible to select the most favorable assembly company, from the price point of view, and/or the most cost-effective servicing company. What this means, in concrete terms, is that baskets and chassis, and selectively other parts too, can be bought, without their being burdened with high transport costs or import duties, by the supermarket chains at the most favorable location in each case, and assembly, as well as the servicing operations which follow later, can be carried out more cost-efficiently. In no way does this turn out to the disadvantage of the manufacturers. On the contrary, each manufacturer can now concentrate on his particular strengths, with the removal of the necessity of having to supply, worldwide, a complete shopping trolley from a local manufacturing operation, coupled with the opportunity of building selected parts with a quality and service life which is appropriate in each case, in order to achieve an improved profit situation within the specialization.

Should it be necessary to upgrade the intended purpose of the chassis and to regard the usefulness of baskets of different size as being more secondary in importance, the invention also allows the development, in cost-effective manner, of ranges of shopping trolleys in which the share accounted for by the chassis is larger than the corresponding share accounted for by the baskets.

### BRIEF DESCRIPTION OF THE DRAWINGS

The invention will be explained in greater detail with the aid of exemplified embodiments. In the drawings,

FIGS. 1 to 5 show, in side view, shopping trolleys with different connecting means. As suitable exemplified embodiments, moreover,

FIG. 6 shows, in a plan view, three different shopping trolleys which form a range of shopping trolleys and have identical connecting means;

FIG. 7 shows an actual exemplified embodiment in a rear view;

FIG. 8 shows the same exemplified embodiment, viewed from above;

FIG. 9 shows, in a sectional representation, one possibility for fastening a basket to a chassis with the aid of a single connecting means;

FIG. 10 shows an exemplified embodiment having a basket which is attached to a chassis by latching-type locking; and

FIG. 11 shows two shopping trolleys which are inserted in one another in a space-saving manner.

### DESCRIPTION OF THE PREFERRED EMBODIMENT

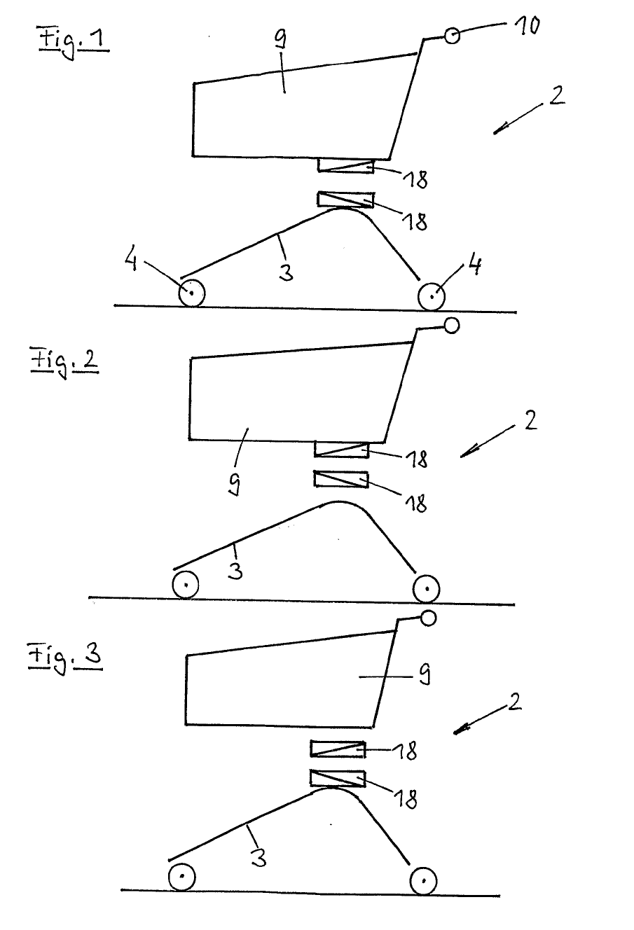

As an abstract of the exemplified embodiments represented below, those chassis 3 and baskets 9 of the shopping trolleys 2 which have been shown always have the same basic shape in terms of their design. Obviously, the invention allows a diversity of differently constructed chassis 3 and baskets 9. For the sake of simplicity, the at least one connecting means 18, which quite generally forms a connecting apparatus, is also represented diagrammatically in FIGS. 1 to 5 of the drawings in the form of a one-part or two-part block, it being possible to use connecting means 18 of the most diverse kinds. One only has to think of struts, plates, webs, pegs, bolts, pins, etc. which are equipped with, and/or form latching connections with, undercuts or projections, with holes or perforations, as the case may be. All the connecting means 18, which are usually formed from metal or plastic or both, allow the development of common connecting points 23 which form an immovable connection, which can usually be undone again if necessary, between a chassis 3 and a basket 9 belonging to a shopping trolley 2. In known fashion, the shopping trolleys 2 described herein are designed in such a way that they can be inserted in identical shopping trolleys 2 in a space-saving manner.

In the following representations (FIGS. 1 to 5), the chassis 3, which are equipped with castors 4, the baskets 9, which usually carry a pushing handle 10, and the connecting means 18 required for them are represented detached from one another, that is to say in the condition in which they are to be assembled. In the examples, the baskets 9, which preferably consist, in known manner, of a basket body with a rear closing flap movably arranged thereon, are attached to the chassis 3 from above. Other methods of assembly are naturally also conceivable for the purposes of the invention. Thus, it is entirely possible to push the basket 9 onto the chassis 3 in a kind of horizontal longitudinal movement, provided that the connecting means 18 are designed in a suitable manner.

FIG. 1 shows a chassis 3 and a basket 9 with connecting means 18 which are arranged in an immovable manner on the basket 9 and chassis 3 in each case. In the assembled condition, the chassis 3 and basket 9 form a shopping trolley 2 such as is also represented in FIGS. 2 to 5. The shopping trolleys 2 which are suitable for this solution are, for example, ones whose chassis 3 and baskets 9 are manufactured from plastic, and the connecting means 18 are moulded, together with suitable connecting points 23, onto the chassis 3 and basket 9 in each case. The exemplified embodiment corresponding to FIG. 10, which embodiment will be described in greater detail below, can also be ranked among this kind of shopping trolley 2.

FIG. 2 brings together a chassis 3 and a basket 9, wherein the single connecting means 18 or plurality of connecting means 18 can be slipped onto the chassis 3, whereas the connecting means 18 on the basket are arranged in an immovable manner. The shopping trolleys 2 which are suitable as practical exemplified embodiments are ones whose baskets 9 consist of plastic and have suitable connecting means 18 moulded onto them.

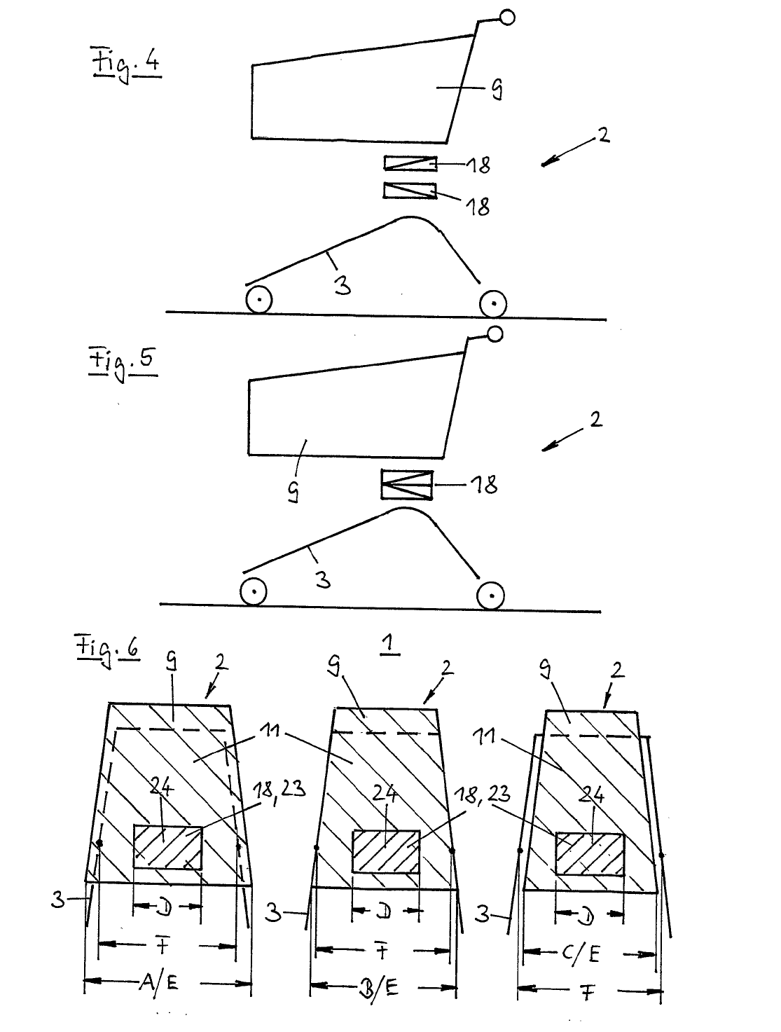

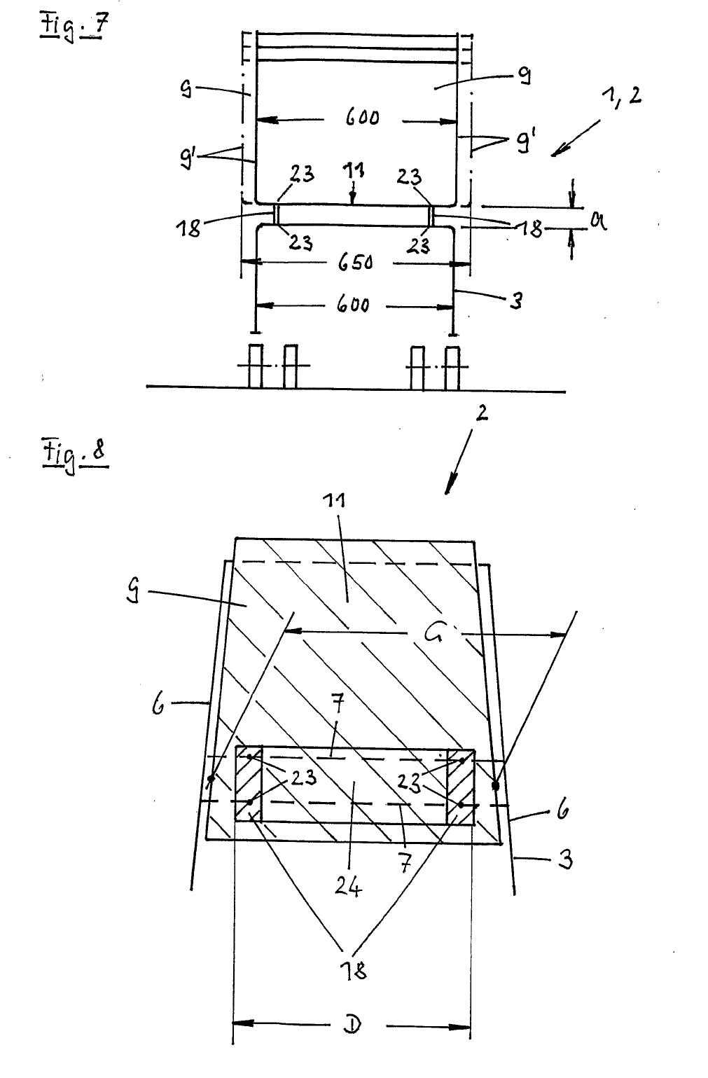

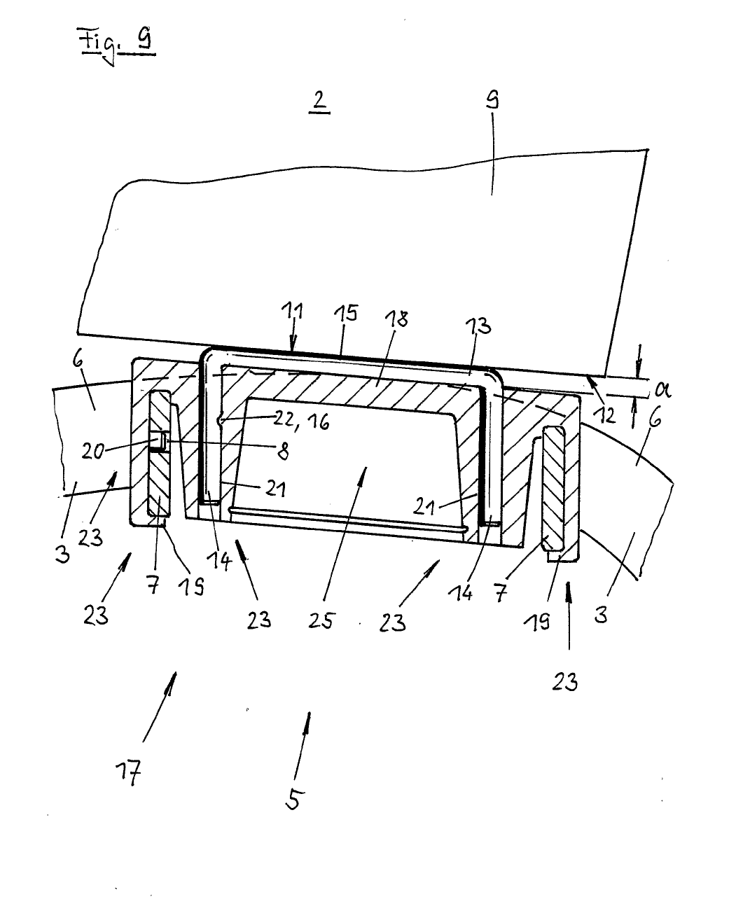

FIG. 3 discloses a chassis 3 with connecting means 18 arranged on it in an immovable manner, while the connecting means 18 can be slipped onto the basket 9. In this exemplified embodiment, the chassis 3 consist of plastic, the connecting means 18 being moulded onto them.

It can be seen from FIG. 4 that shopping trolleys 2 are also possible in which the connecting means 18 are designed so that they can be slipped both onto the chassis 3 and onto the basket 9. When shopping trolleys 2 of this kind are assembled, the respective connecting means 18 engage in one another so that the baskets 9 are preferably connected to the chassis 3 by latching-type locking.

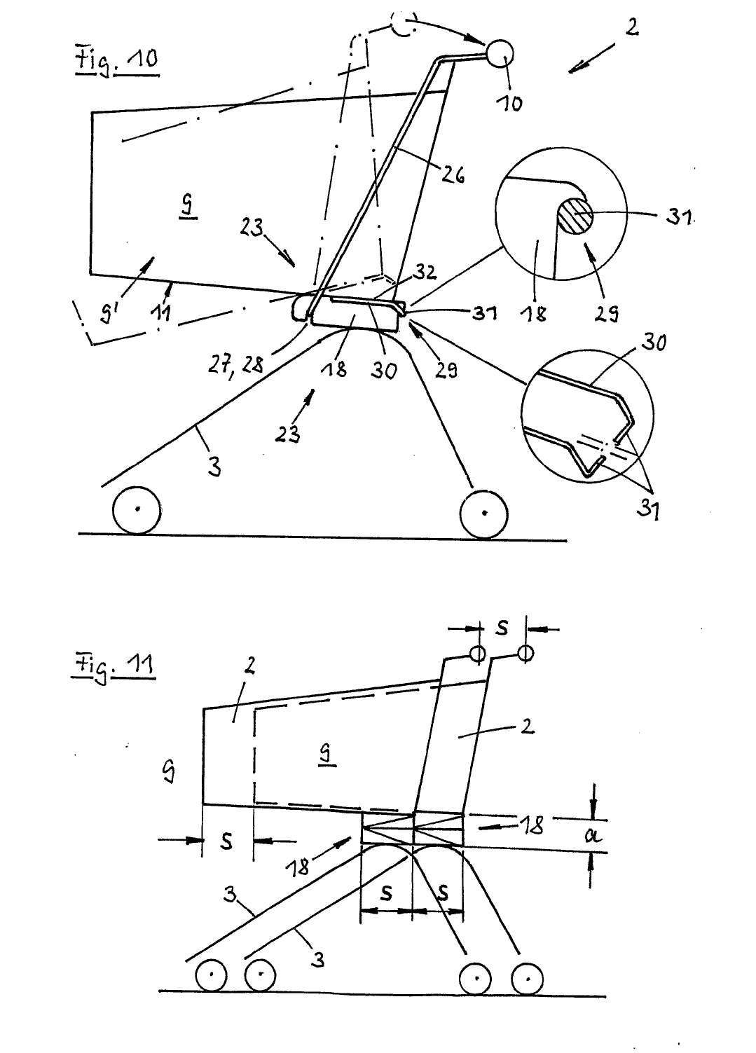

FIG. 5 shows that it is possible to establish the connection between the chassis 3 and the basket 9 with the aid of a single connecting means which is connected, both to the basket 9 and to the chassis 3, in a detachable manner or so that it can be slipped on. The exemplified embodiment according to FIG. 9 which is described below can be classed in this category.

FIG. 6 shows, in a plan view, a range 1 of shopping trolleys which, for the sake of simplicity, consists of only three different shopping trolleys 2. The chassis 3 is identical in the case of all three shopping trolleys 2. The basket 9, on the other hand, is designed with a different width in each of the shopping trolleys 2—cf. the dimensions A, B and C. In the case of each shopping trolley 2, there has been illustrated a portion 24 of area in which the at least one connecting means 18, and the common connecting points 23 formed thereby, are located. At the same time, the connecting points 23 lie, viewed from above, within the portion 24 of area, which is narrower (dimension D) than the maximum width E of the bottom 11 of the basket, said bottom being usually of trapezoidal design, and is preferably narrower than the width F of the chassis 3, measured at the level of said portion 24 of area. The drawing shows, in a clarifying manner, the base area, which is identified by hatching, of the trapezoidal bottom 11 of the basket. The base area of the bottom 11 of the basket does not include the sidewalls 9′ of the basket 9. In the shopping trolleys 2 represented, it can be seen that, in the case of the shopping trolley 2 represented on the left, the width of the basket 9 is greater than the width of the chassis 3, measured at the level of the portion 24 of area. In the case of the shopping trolley 2 represented in the middle, the widths, which are measured in the corresponding manner, of the chassis 3 and basket 9 are identical, while in the case of the shopping trolley 2 represented on the right, the basket 9 is narrower than the width of the chassis 3, measured at the level of the portion 24 of area. It can easily be imagined, with the aid of this example, that it is also possible to design each of the baskets 9 shown to be of different height and/or of different length. In all the shopping trolleys 2 belonging to the range 1 of shopping trolleys, the connecting means 18 and connecting points 23 are always arranged in an identical manner, preferably centrally. It is thus possible, with a single size of chassis, to manufacture different shopping trolleys 2 which form a range of shopping trolleys with preferably different basket sizes or basket capacities.

FIG. 7 shows, in a simplified representation, a rear view of a shopping trolley 2 in which two baskets 9 with different widths are illustrated. The benefit of the invention becomes clear with the aid of an actual situation. Because of a legal standard, shopping trolleys 2 in France may not be more than 600 mm wide, whereas a maximum width of 650 mm is allowed, at least in the rest of Europe. The drawing shows one shopping trolley 2 in each case, which trolleys together form a range 1 of shopping trolleys. It is possible to make out the chassis 3 which measures 600 mm in width and carries two connecting means 18. The way in which the two connecting means 18 are connected to the basket 9 and chassis 3 can be chosen in accordance with one of the fastening possibilities portrayed in FIGS. 1 to 5. At any rate, the arrangement at least of the connecting points 23 which correspond with the basket 9, viewed from above, with respect to the outline of the basket 9 or of the bottom 11 of said basket, is chosen in such a way that baskets 9 of different widths can be selectively attached to one and the same chassis 3, the arrangement at least of the connecting points 23 which correspond with the basket 9 being identical in both the shopping trolleys 2, and thereby in all the shopping trolleys 2 of this type. This is manifested in the drawings through the fact that a basket 9 with a width of 600 mm (France) is illustrated in continuous lines, and that a basket with a width of 650 mm (rest of Europe) is represented by means of chain-dotted lines. The basket of the shopping trolley last mentioned projects beyond the chassis 3 by 25 mm on either side. In this instance, the range 1 of shopping trolleys consists of at least two shopping trolleys 2 which both have the same chassis but have baskets 9 of different widths. This solution is possible because the sidewalls 9′ of the basket 9 in both shopping trolleys 2 no longer interact with the connecting means 18. The distance between the two connecting means 18 is smaller than the maximum width of the baskets 9 in each case, and narrower than the width of the chassis 3.

As an alternative to the exemplified embodiment just described, it can be easily imagined, with the aid of the drawing, that it is possible, while keeping the width of the basket 9 constant, to use chassis 3 of different widths in order to form a range of shopping trolleys made up of at least two different shopping trolleys 2. In this case, the arrangement at least of the connecting points 23 which correspond with the chassis 3, viewed from above, with respect to the outline of said chassis 3, is chosen in such a way that one and the same basket 9 can be selectively attached to chassis 3 of different widths, the arrangement at least of the connecting points 23 which correspond with the chassis 3 being identical in all the shopping trolleys 2.

With the aid of the drawing, it can be seen that a distance, a, is formed between the uppermost boundary of the chassis 3 and the bottom 11 of the basket, and this can also be inferred from the exemplified embodiments in FIGS. 9 and 11.

Supplementing FIG. 7, FIG. 8 shows the exemplified embodiment just described, in a view from above. It is possible to make out the two connecting means 18 which are attached to the chassis 3 at a distance from one another and onto which, in turn, the basket 9 is slipped. Viewed from above, the connecting points 23 are located within a portion 24 of area which is narrower than the largest width G of the bottom 11 of the basket, measured at the level (or in the region) of said portion 24 of area. In the example, the connecting points 23 are also located entirely within the base area, which is identified by coarse hatching, of the bottom 11 of the basket. It is advantageous to arrange the connecting means 18 so that it is immovable on, or can be slipped onto, two transverse struts 7 which usually connect the two longitudinal spars 6 of the chassis 3 in the upper region 5 of said chassis 3 and which are present in any case. Each connecting means 18 thus makes use of two transverse struts 7 for the purpose of fastening it to the chassis 3. The dimensional correlations and technical features portrayed in FIGS. 7 and 8 can be transferred to any range 1 of shopping trolleys.

FIG. 9 shows, in detail and in a sectional representation, the connecting region 17 of the basket 9 and chassis 3 of a shopping trolley 2. The solution proposed here is only one of many conceivable design possibilities. This solution falls back on the exemplified embodiment portrayed in FIG. 5. The drawing shows the upper region 5 of the chassis 3. Said chassis 3 has, in known manner, two upwardly curved longitudinal spars 6. The two longitudinal spars 6 are connected by transverse struts 7 made, for example, of flat steel—see also FIG. 8. A single connecting means 18 consisting of plastic is attached to the two transverse struts 7 from above by latching-type or snap-in locking in such a way that said two transverse struts 7 have projections 19 which are provided on the connecting means 18 partially engaging round them. At least one of the two transverse struts 7 is equipped with at least one horizontally arranged aperture 8 in which at least one peg 20 provided on the connecting means 18 engages. Said connecting means 18 thus assumes a predetermined position which can no longer be altered. In the example, the connecting means 18 has four perpendicularly arranged perforations 21 which are intended for receiving, by latching-type or snap-in locking, four projections located on the underside 12 of the bottom 11 of the basket. Said projections 14 constitute, for example, a constituent part of two clips 13 of U-shaped design which are located on said underside 12 of the bottom 11 of the basket. The clips 12, and thereby the basket 9, rest with their horizontal legs 15 on the connecting part 18 in a positionally fixed manner. Each perforation 21 has a small projection 22 into which a depression 16 located on the projections 19 is latched in each case. The basket 9 is thus connected to the chassis 3 in an immovable manner with the aid of the connecting means 18. In order to obtain the connection shown, the connecting means 18 is first attached to the two transverse struts 7. The basket 9 is then introduced into the perforations 21 with the aid of its projections 14 and is pressed downwards until the latching connection which can be obtained between the projections 22 and depressions 16 has come about. The immovable connection between the basket 9 and the chassis 3 is thus established. Here, “connection by latching-type or snap-in locking” is understood quite generally to mean a connection of two or more parts which manages without additional fastening means such as screws, nuts, pins and the like.

As can be seen from the drawing, common connecting points 23 are formed between the transverse struts 7 and the projections 19, between the aperture 8 and the peg 20, and between the four perforations 21 and the four projections 14. All the connecting points 23 are located within the portion 24 of area portrayed in FIG. 6 or FIG. 8.

The solution proposed here opens up new possibilities. If the connecting means 18 is designed after the fashion of a housing, at least one space 25 is obtained, which is accessible, for instance, from below or from at least one side and which is suitable, for example, for receiving at least one component, for example electrical and/or electronic components, which broaden the function of the shopping trolley 2. The space may also be closed by a suitable closing part which can be removed, for example for the purpose of fitting or changing the electrical or electronic components. The components initially mentioned are increasingly being used in shopping trolleys 2, especially in very recent times, whether it is a matter of wanting to secure the identity of shopping trolleys 2 and their affiliation with specific supermarkets, or of wanting to prevent the theft of said trolleys, or whether it is in order to limit the length of rows of stacked shopping trolleys 2. The components mentioned are always required in all these cases. Since the connecting means 18 has to be relatively large for reasons of strength, this also necessarily results in at least one relatively large space 25 for accommodating these parts, which are preferably electric and electronic ones. It is therefore possible to accommodate, for example, a large and therefore long-lasting current supply made up of batteries, something which has hitherto always been unsuccessful because of problems of space. The accommodating of the electrical and electronic components likewise gives rise to no difficulties, since these components now take up little space and room because of their small size.

It should not go unmentioned at this point that it is naturally possible to provide, instead of one connecting means 18 such as has just been described, two connecting means 18 which are, for example, of mirror-inverted design, are a development, so to speak, from the single connecting means 18, and likewise possess properties and technical features exhibited by the one-piece connecting means 18 initially described, which consists of plastic. Each of these connecting means 18 possesses, for example, two perforations 21 for receiving two projections 14. It is also possible for each of the two connecting means 18 to be equipped with another peg 20 which engages in another aperture 8 located on the other transverse strut 7. The two connecting means 18 can thus be fastened, in an identical or similar way, referred to the one-piece connecting means 18, to two transverse struts 7 in each case, and they are likewise located in the portion 24 of area already described—see FIGS. 6 and/or 8 as an example. At least one of the two connecting means 18 has at least one space 25 for receiving at least one component which broadens the function of the shopping trolley 2.

FIG. 10 shows an exemplified embodiment in which the basket 9 can be attached to a chassis 3 of a shopping trolley 2 by latching-type locking with the aid of at least one connecting means 18. Two connecting means 18 which are kept at a distance are, for example, welded or fastened onto the chassis 3 in the same way as has been proposed in the example according to FIG. 7. Each connecting means 18 is designed as a web which is arranged on edge, the obvious thing to do being also to weld the two web-like connecting means 18 onto the two transverse struts 7—cf. FIG. 8. At its front end, each connecting means 18 has a hook-in eyelet 28. The rear end of each hook-in means 18 is designed as a latching depression 29. A bar portion 26 leads downwards, starting from the pushing handle 10, on the outside of each of the two sidewalls 9′ of the basket 9, and continues downwards beyond the bottom 11 of said basket. The two bar portions 26 are then bent over at right angles and lead towards one another, underneath the bottom 11 of the basket, in order, for example, to form a single transverse web 27. The basket 9 can be hooked into the hook-in eyelets 28 in the course of an assembling operation by means of the transverse web 27 or projections of corresponding design, so that said basket 9 assumes a first preset position. A U-shaped clip 30 is arranged on the underside of the bottom 11 of the basket in an immovable manner by means of its legs 32. Said clip 30 is angled so as to point obliquely downwards at its rear end—see detail—so that the transverse piece 32 of the clip 30 is located furthest downwards. In the course of the assembling operation, the basket 9 is preset on the two connecting means 18 with the aid of the hook-in eyelets 28 and is pressed downwards by means of the pushing handle 10 until the transverse piece 31 of the clip 30 latches in against the latching depressions 29 in the two connecting means 18—see the other detail. In this position, the basket 9 is connected to the chassis 3 by latching-type locking and in an immovable manner with the aid of the connecting means 18. Under these circumstances, the legs 32 of the clip 30 and the two bar portions 26 of the basket 9 rest against the outer sides of the connecting means 18. At least the common connecting points 23 between the basket 9 and the connecting means 18 are chosen, viewed from above, with reference to the outline of the basket 9 and with respect to their position, in such a way that baskets of different widths can be selectively attached to the chassis 3 in order to form a range of shopping trolleys. The connecting points 23 just mentioned are preferably located within the outline of the bottom 11 of the basket. The same can also be applied to the connecting points 23 located between the chassis 3 and the connecting means 18. In the case of all the shopping trolleys 2 forming the range 1 of shopping trolleys, the design of the connecting means 18 and the arrangement of the connecting points 23 are always identical, it being possible to regard both the transverse web 27 and the transverse piece 31 likewise as connecting means 18 having connecting points 23.

Finally, FIG. 11 shows two identical shopping trolleys 2 from a range 1 of shopping trolleys, which are inserted in one another in a space-saving manner. At least one connecting means 18 with the appertaining connecting points 23 is arranged on each shopping trolley 2. The at least one connecting means 18 connects the basket 9 to the chassis 3 as has been described. Both the baskets 9 and the chassis 3 are partially inserted in one another. The connecting means 18 of the two shopping trolleys 2 strike against one another. The dimensions S indicate the length of the so-called “stacking distance” which is achieved when the two shopping trolleys 2 cannot be inserted in one another any further. In the example, the length of each connecting means 18 corresponds to the stacking distance S. In a supplementary manner, the dimension S is also illustrated between the pushing handles 10 on the two shopping trolleys 2 in order to make it clear that said dimension S comes about at all the same positions or points on the two shopping trolleys 2.

In conclusion, it remains to be observed that the description of the inventive solutions has naturally emphasized those features which prove particularly favorable for implementing the invention. These include the fact that the arrangement of the connecting means 18 and the position of the appertaining connecting points are usually identical in all the shopping trolleys 2. However, the invention permits ranges (1) of shopping trolleys, and also shopping trolleys 2 which are suitable for forming the said ranges, in which either only the arrangement of the connecting points (23) corresponding with the basket (9) or only the arrangement of the connecting points 23 corresponding with the chassis (3) is identical. This means that, if the arrangement of the connecting points 23 which correspond with the basket 9 is identical, it is also possible for the arrangement of the connecting points 23 which correspond with the chassis 3 to be of completely different design, and alternatively vice versa, in the case of different shopping trolleys 2 belonging to the range 1 of shopping trolleys, if this should prove expedient in individual cases.

1-17. (canceled)

18. A range of shopping trolleys comprising:
at least two different shopping trolleys, each of which having a chassis and a basket carried by said chassis, wherein identical shopping trolleys can be parked in rows in such a way that both their said baskets and their chassis are partially inserted in one another, and also wherein at least one connecting means located underneath the bottom of said basket and outside sidewalls of the latter is provided, which has connecting points which allow immovable fastening of said basket on said chassis in the course of an assembling operation;
wherein said shopping trolleys differ at least in the different widths of their said baskets, or at least in the different widths of their said chassis, and that the arrangement, at least of said connecting points which correspond with said basket or, alternatively, at least of said connecting points which correspond with said chassis, is identical in all said shopping trolleys.

19. The range of shopping trolleys according to claim 18, wherein the arrangement of said at least one connecting means is identical in all said shopping trolleys.

20. The range of shopping trolleys according to claim 19, wherein said at least one connecting means assembles said basket to said chassis by an arrangement selected from the group consisting of an immovable manner on said basket and on said chassis, said at least one connecting means being slipped onto said chassis and is immovable on said basket, said at least one connecting means being immovable on the chassis and is slipped onto said basket, and said at least one connecting means is slipped onto said chassis and said basket.

21. The range of shopping trolleys according to claim 19, wherein said connecting means is slipped onto said chassis, and that said basket is attachable to said connecting means.

22. The range of shopping trolleys according to claim 18, wherein said connecting points, viewed from above, are located within a portion of area which is either narrower than the width of said bottom of said basket of the particular shopping trolley, measured at the level of said portion of area, or that the portion of are containing said connecting points, likewise viewed from above, is located within a base area of said bottom of said basket of the particular shopping trolley.

23. The range of shopping trolleys according to claim 22, wherein said basket of each of said shopping trolleys at the level of said portion of area is wider than, or the same width as, or narrower than said chassis.

24. The range of shopping trolleys according to claim 19, wherein said basket of each of said shopping trolleys is attachable to said chassis by latching-type locking with the aid of the at least one connecting means.

25. The range of shopping trolleys according to claim 18, wherein said at least one connecting means is attachable to two transverse struts which connect longitudinal spars of each of said shopping trolleys.

26. The range of shopping trolleys according to claim 18, wherein said at least one connecting means is provided for the purpose of determining the stacking distance between said shopping trolleys.

27. The range of shopping trolleys according to claim 18, wherein said at least one connecting means has at least one space for receiving at least one component which is capable of broadening the function of said shopping trolleys.

28. A shopping trolley for forming a range of shopping trolleys, said shopping trolley comprising:
a chassis;
a basket carried by said chassis, said basket having a bottom and outside sidewalls; and
at least one connecting means located underneath said bottom of said basket and outside said sidewalls of the latter is provided, said at least one connecting means having connecting points which allow immovable fastening of said basket on said chassis in the course of an assembling operation;
wherein said shopping trolley can be parked, together with other identical shopping trolleys, in rows in such a way that both their said chassis and their said baskets are partially inserted in one another;
wherein at least said at least one connecting points which correspond with said basket are designed in such a way that said basket can be attached to said at least one connecting means by latching-type locking.

29. The shopping trolley according to claim 28, wherein the arrangement of said connecting points which correspond with said basket, viewed from above, with respect to the outline of said basket is chosen in such a way that baskets of different widths is selectively attached to said chassis, or that the arrangement of said connecting points which correspond with said chassis, viewed from above, with respect to the outline of said chassis, is chosen in such a way that said basket is selectively attached to chassis of different widths.

30. The shopping trolley according to claim 28, wherein said at least one connecting means is formed by at least one part and is slipped onto said chassis, and that said basket is, in turn, attached to said at least one connecting means.

31. The shopping trolley according to claim 28, wherein a distance is formed between an uppermost boundary of said chassis and said bottom of said basket.

32. The shopping trolley according to claim 28, wherein said at least one connecting means is provided for the purpose of determining the stacking distance between two identical shopping trolleys.

33. The shopping trolley according to claim 28, wherein said at least one connecting means has at least one defined space for receiving at least one component which is capable of broadening the function of said shopping trolley.

34. The shopping trolley according to claim 33, wherein said space is accessible from below or from one side, and is selectively closable.

35. The shopping trolley according to claim 28, wherein said chassis further comprising an upper region having at least two upwardly curved longitudinal spars connected by at least two transverse struts, wherein at least one of said two transverse struts defines at least one horizontally arranged aperture.

36. The shopping trolley according to claim 35, wherein said at least one connecting means being attachable to said two transverse struts from above by a latching-type locking, said at least one connecting means being provided with at least two projections each being adapted to partially engage a corresponding transverse strut, and wherein said at least one connecting means comprising at least four perpendicularly arranged perforations adapted for receiving at least four projections located on the underside of said bottom of said basket by latching-type locking, said at least one connecting means further comprising at least one peg for engaging said aperture of said at least one transverse strut.

37. A shopping trolley system for forming a range of shopping trolleys, said shopping trolley system comprising:
a chassis having attachable castors, and an upper region, said upper region comprising of at least two upwardly curved longitudinal spars connected by at least two transverse struts, wherein at least one of said two transverse struts defines at least one horizontally arranged aperture;
a basket carried by said chassis, said basket having a bottom, outside sidewalls, and a rear closing flap movably arranged thereon; and
at least one connecting means located underneath said bottom of said basket and outside said sidewalls, said at least one connecting means being attachable to said two transverse struts from above by a snap-in locking, said at least one connecting means being provided with at least two projections each being adapted to partially engage a corresponding transverse strut, said at least one connecting means comprising at least four perpendicularly arranged perforations adapted for receiving at least four projections located on the underside of said bottom of said basket by snap-in locking, said at least one connecting means further comprising at least one peg for engaging said aperture of said at least one transverse strut;
wherein said shopping trolley can be parked, together with other identical shopping trolleys, in rows in such a way that both their said chassis and their said baskets are partially inserted in one another;
wherein each perforation of said connecting means has a projection into which a depression located on said projections of said basket is latched thereto;
wherein said at least one connecting means having at least one defined space for receiving at least one component therein.
